(19) United States
(12) Patent Application Publication
(10) Pub. No.: US 2025/0260299 A1
(43) Pub. Date: Aug. 14, 2025

(54) ELECTRONICALLY COMMUTATED ELECTRIC MOTOR WITH LIQUID COOLING

(71) Applicant: Maxon International AG, Sachseln (CH)

(72) Inventor: Arnold TEIMEL, Giswil (CH)

(21) Appl. No.: 18/845,289

(22) PCT Filed: Mar. 10, 2023
(86) PCT No.: PCT/EP2023/056163

§ 371 Date: Sep. 9, 2024

(30) Foreign Application Priority Data
Mar. 11, 2022 (EP) 22161690.7

(51) Int. Cl. H02K 29/08; H02K 3/28; H02K 5/10; H02K 9/19; H02K 11/00

(52) U.S. Cl. CPC H02K 29/08; H02K 3/28; H02K 5/10; H02K 9/19; H02K 11/0094; H02K 2203/09

(57) ABSTRACT

The electric motor has a liquid-cooled stator with an ironless hollow-cylinder stator winding and a coolant circuit for conducting a coolant through the electric motor. The electric motor also has a rotor arranged rotatably concentrically to the stator, a motor housing accommodating the stator and the rotor, a connection assembly and at least one electrical connection line for electrically connecting the stator winding. A connection assembly for such an electronically commutated electric motor is also provided. The connection assembly has a closure cover, at least one plug-in connection means for establishing electrical contact between the stator winding and the electrical connection line, and also a sealing element between the plug-in connection means and a housing of the connection assembly. The connection assembly implements fluid-tight sealing of the motor housing.

### CROSS-REFERENCE TO RELATED APPLICATIONS

This application claims priority to PCT Patent App. No. PCT/EP2023/056163, filed on Mar. 10, 2023, and entitled “ELECTRONICALLY COMMUTATED ELECTRIC MOTOR WITH LIQUID COOLING” and to European Patent App. No. 22161690.7, filed Mar. 11, 2022, and entitled “ELECTRONICALLY COMMUTATED ELECTRIC MOTOR WITH LIQUID COOLING.”

### BACKGROUND

### 1. Field

The present disclosure relates to an electronically commutated electric motor having a liquid-cooled stator and also to a connection assembly for such an electronically commutated electric motor.

### 2. Related Art

Electric motors having a liquid-cooled stator are known in the art and are used in various applications in which sufficient cooling of the waste heat generated by the power loss of the electric motor is not guaranteed. Such liquid-cooled electric motors are used in aviation, automotive engineering and air conditioning technology as well as in aerospace, raw material extraction and power plant technology.

A generic liquid-cooled electric motor is known, for example, from U.S. Pat. No. 6,489,697 B1. This electric motor has a hollow cylindrical stator winding, which is enclosed by a soft magnetic reverse circuit connection, and a rotor arranged concentrically to the stator so that it can rotate. The stator winding with the reverse circuit connection and the rotor are accommodated in a motor housing, which is provided with a closure cover on both sides. An oil circuit is provided to dissipate the heat loss generated at the stator winding and the reverse circuit connection, wherein the cooling medium first flows in an axial direction past the inner circumference of the stator winding and then past the outer circumference of the reverse circuit connection. A ceramic sleeve is provided between the stator winding and the rotor, which defines both the running gap to the rotor and the hollow cylindrical flow channel for the coolant between the ceramic sleeve and the stator winding. However, the design of this liquid-cooled electric motor is relatively complex and therefore both cost-intensive to produce and prone to faults during operation. Due to the active cooling system, this electric motor must be serviced at regular intervals.

There are also electric motors that are hermetically sealed for use in extreme environmental conditions. The areas of application for such hermetically sealed electric motors range from automotive applications to medical technology. DE 38 04 677 A1, for example, describes such an electric motor with a watertight seal of the cable feed-through between the housing end edge and a closure cover, wherein a contact pin provided outside the housing for the plug contact is connected to an electrical connection cables via a circuit board in the closure cover and cable cores with a stator winding. The publication U.S. Pat. No. 10,389,202 B2 also shows a hermetically sealed electric motor in which contact pins protruding outside the motor housing are connected to the stator windings via a printed circuit board embedded in the closure cover. In addition to the contact pins and the circuit boards, the motor control unit is also embedded in the motor housing's closure cover. The latter two documents do not show an electric motor in which a coolant flows through the motor.

### SUMMARY OF THE INVENTION

It is the task of the present disclosure to improve an electronically commutated electric motor of the type mentioned above with regard to the simplicity of assembly, trouble-free operation and simple construction.

This task is solved in that the connection assembly is configured with a closure cover and at least one plug-in connecting means for electrically contacting the electrical connection cables with a corresponding plug-in connecting part of the stator winding of the stator, and in that the connection assembly effects a fluid-tight sealing of the motor housing, wherein a sealing element is provided between the plug-in connecting means and a housing of the connection assembly. This connection of a stator winding of such a hollow cylindrically shaped stator with a preferably slotless stator winding enables the motor housing to be sealed against a liquid leakage, in particular against a coolant of a coolant circuit. In addition, the fluid-tight connection of the connection assembly with the motor housing prevents substances surrounding the electric motor, such as liquids or gases, from reaching the electrical contacts of the motor housing or entering into the motor housing and damaging the electric motor. Furthermore, the simple electrical contact of the stator winding to the electrical connection cables is possible by means of an electrical plug connection. The connection assembly configured as a closure cover for closing an open front side of the motor housing is configured as a separate component that is provided during assembly of the electric motor and is firmly connected to the motor housing, for example by means of a screw connection or a clip connection. In one variant, the connection assembly can also be configured to be removable and replaceable if necessary. In an electric motor according to the present disclosure, the electrical contact of the stator winding of the stator with the electrical connection cables takes place within the connection assembly or within the motor housing, which is sealed off from the surroundings by the connection assembly. The electrical contact between the plug-in connecting means and the electrical connection cables leading into the connection assembly is accordingly further designed within the connection assembly. The electrical contact between the electrical connection cable and the stator winding is made in the connection assembly by the plug-in connecting means, which is connected to the electrical connection cable, and the plug-in connecting part, which is connected to the stator winding.

The stator winding is preferably formed by several individual coils, particularly preferably by twelve individual coils. The individual coils are preferably connected by means of a star or delta connection to form a three-phase winding system with three stator winding phases. Each winding phase preferably consists of four individual coils.

In a particularly preferred embodiment, the stator has a stator winding with three stator winding phases and three plug-in connecting means, each connected to a stator winding phase, which are positioned on the first side of the motor housing, and the connection assembly has three plug-in connecting means, each of which is connected to an electrical connection cable. Preferably, the individual stator winding phases are formed by several individual coils, particularly preferably by four individual coils. The individual coils are preferably connected by means of a star or delta connection to form a three-phase winding system. A three-phase winding system enables the rotor to be started or stopped from or in any stopping position, while at the same time the wiring effort for three phases is relatively low.

In an advantageous embodiment, the rotor comprises at least one permanent magnet or several permanent magnet segments distributed around the circumference. The rotor is preferably designed with two, four or six poles. Advantageously, permanent magnets distributed around the circumference are arranged in a Halbach arrangement, wherein several permanent magnet segments, in particular two permanent magnet segments, form a magnetic pole. A particularly high torque can be generated by such a multi-pole pair design of the permanent magnet arrangement.

In a preferred embodiment of the mounting of the connection assembly to the motor housing, the plug-in connecting means connected to an electrical connection cable is connected to a corresponding plug-in connecting part of the stator winding by sliding it on, while the connection assembly is attached to the motor housing. In addition to the very simple installation, different connection assemblies can also be used without replacing or adapting the stator and the rotor, which is rotatably arranged within the inner circumference of the stator.

In a simple variant, the plug-in connecting means of the connection assembly can be configured as a plug socket, and the corresponding plug-in connecting part of the stator winding is preferably configured as a contact pin. Such a plug socket enables a simple detachable plug-in connection for making electrical contact of the electrical connection cables with the stator winding. A plug-in connection part complementary to the plug socket, for example a contact pin, is connected directly to the stator winding of the stator and thus enables power supply of the stator winding via a simple plug connection between the connection assembly and the motor housing.

Advantageously, an O-ring can be provided as a sealing element between the plug socket and a housing of the connection assembly. For very high requirements regarding the tightness of the connection assembly with respect to the electrical connection cable, in addition to the inherent sealing effect of the electrical connection cable embedded in the connection assembly and the embedded plug socket, an O-ring can be arranged as a sealing element in a gap between the plug socket and the housing of the connection assembly.

In a suitable embodiment, a radial seal is provided between the connection assembly and the motor housing. The radial seal enables secure sealing of the interface between the motor housing and the connection assembly, so that high sealing requirements can be met both from the outside to the inside and from the inside to the outside. Optionally, in addition to the radial seal, a supplementary axial seal, for example a flange seal, can be provided between the connection assembly and the motor housing in order to improve the tightness against leakage of coolant from the cooling circuit and the durability of the seal between the connection assembly and the motor housing.

According to a further embodiment, a cable assembly is provided, wherein the cable assembly comprises the electrical connection cables, the plug-in connecting means and at least one busbar for electrically connecting the electrical connection cables with the plug-in connecting means. Such a prefabricated cable assembly makes it easier to manufacture the connection assembly, in particular in the case of injection molding or mold casting of the connection assembly, and ensures good sealing of the electrical contact between the electrical connection cables or the busbar and the housing of the connection assembly. The connection between the busbar and the plug-in connecting means is preferably made by pressing, welding or soldering. On the other side, the electrical connection cables are connected with the busbar, in particular by welding or soldering. Depending on the number of stator winding phases of the stator, the cable assembly can have several electrical connection cables, busbars and plug-in connecting means, which are combined into a common cable assembly for time-saving further processing. During the manufacturing process of the connection assembly, the cable assembly is held in a defined position in a forming tool so that when the connection assembly is later mounted on the open front side or on the first side of the motor housing, the position of the plug-in connecting means exactly matches the position of the plug-in connection parts positioned on the motor housing and connected to the stator winding phases of the stator.

Preferably, the cable assembly may have three electrical connection cables, three sockets and three busbars, wherein the three electrical connection cables, the three sockets and the three busbars are mechanically connected to each other. Combining several connection components into a common cable assembly makes it easy to handle the common cable assembly when manufacturing the connection assembly.

A practical embodiment provides that the connection assembly is made of a thermoplastic or thermosetting resin by means of injection molding or mold casting, wherein connection electronics having the electrical connection cables and the plug-in connecting means are embedded in the connection assembly. The connection electronics enable a simple electrical contact of the individual stator winding phases to a power supply, wherein this electrical interface is injection-molded or encapsulated in the connection assembly. The connection electronics can be configured in the form of an assembled circuit board having all the necessary components and connection cables.

In a further modification, a commutation electronics for commutating the electric motor are provided, wherein the commutation electronics are also embedded in the connection assembly. This eliminates the need for separate provision and arrangement of the commutation electronics on the motor housing. The commutation electronics is configured in particular as a printed circuit board with all the necessary elements, electronic components and cables and can optionally be combined with the connection electronics. Furthermore, the commutation electronics may also have an integrated sensor, preferably a magnetic field-sensitive angular position sensor, which in particular detects the magnetic field of a diametrical control magnet mounted at the end of a rotor shaft. Such an integrated position sensor enables simple control of an electronically commutated electric motor.

One particular embodiment provides that the connection electronics and/or the commutation electronics are provided with an additional layer of a thermoplastic or thermosetting resin, which is applied in an upstream first step by means of injection molding, transfer molding or mold casting. As a result, the sensitive electrical and electronic components are double overmolded and/or encapsulated in a two-stage process and are therefore specially protected. When manufacturing the connection assembly, the connection electronics and/or the commutation electronics are therefore overmolded on all sides in a first process step with all circuit boards, elements and cables having a defined material thickness of a preferably thermoplastic resin. For a hermetic seal, these already encapsulated components are embedded a second time in a thermoplastic or thermosetting resin in the second process step, which also securely seals possible holding positions from the first process step. In addition to sealing the components, the housing shape of the connection assembly with integrated closure cover is also configured in this second process step.

An advantageous embodiment further provides that the coolant circuit for passing a coolant through the electric motor has a first coolant channel between the motor housing and the outer circumference of the stator, a second coolant channel between the inner circumference of the stator and the rotor and a coolant redirection for fluid connection of the first coolant channel and the second coolant channel, wherein the coolant redirection is configured, preferably at least partially, by the connection assembly. In an electric motor according to the present disclosure, oil or a special heat transfer fluid, preferably having a boiling point of over 200° C., is used in particular as coolant. Effective cooling of the electric motor is achieved by passing such a coolant through the coolant circuit. At the gap between the outer wall of the motor housing and the outer circumference of the stator, the coolant absorbs the corresponding magnetic and eddy current losses of the reverse circuit material. The ohmic losses and eddy current losses in the stator winding are dissipated as the coolant flows through the running gap between the inner circumference of the stator and the rotor. This means that the two heat-emitting components, the stator winding and the reverse circuit, are in direct contact with the coolant and thus enable optimum heat dissipation. The coolant circuit preferably enables a flow rate of 2 to 7 liters per minute. The coolant is forced through the coolant circuit having a pressure of between 1 and 10 bar, preferably between 3 and 5 bar. A thermal power loss of the electric motor of 3 kW, 5 kW or more can be dissipated by the coolant.

A reasonable design provides that the second coolant channel between the inner circumference of the stator and the rotor has a smaller cross-sectional area than the first coolant channel between the motor housing and the outer circumference of the stator. As most of the power loss and therefore the heat development occurs in the stator winding when the electric motor is under high load, the narrower cross-section in the running gap between the stator winding and the rotor enables better heat transfer and lower thermal load on the electric motor via a turbulent flow of the coolant. Furthermore, a high torque cannot be generated with a large air gap between the stator and rotor or a small air gap is required to generate a high torque.

In a modification of the connection assembly, the coolant redirection can be configured as a hole or aperture in the connection assembly. This enables targeted deflection of the coolant in the coolant circuit and avoids standstill zones and deposits in the coolant circuit. Accordingly, a coolant redirection configured in the connection assembly for fluid connection of the first and second coolant channels can contribute to improved heat transfer.

A practical variant provides that the coolant circuit has a coolant inlet to the first coolant channel arranged on the circumference of the motor housing and preferably has a coolant outlet from the second coolant channel, wherein the coolant outlet is arranged on a second side of the motor housing opposite the connection assembly. The coolant flows directly into the gap between the motor housing and the outer circumference of the stator via the coolant inlet on the motor housing, which can for example be configured as holes distributed around the circumference, and then via the coolant redirection and the second coolant channel to the outlet provided on the second side of the motor housing, which in turn can be configured as holes. As a result, the output-side ball bearing of the motor shaft may be cooled and supplied with lubricant by the oil used as coolant.

In an alternative embodiment, the coolant inlet and coolant outlet may be designed reversed, so that the coolant inlet is provided on the second side of the motor housing and the coolant outlet on the circumference of the motor housing. In this embodiment, the coolant flows from the alternative coolant inlet on the second side of the motor housing first through the second coolant channel and then via the coolant redirection through the first coolant channel to the alternative coolant outlet on the circumference of the motor housing.

A further advantageous embodiment provides that the connection assembly effects a fluid-tight sealing between the electrical contacts of the plug-in connecting means of the electrical connection cable with the corresponding plug-in connecting part of the stator winding of the stator and the coolant circuit of the electric motor.

Furthermore, the present disclosure relates to a connection assembly for an electronically commutated electric motor according to one of the previously described embodiments, wherein the connection assembly has a closure cover of the electronically commutated electric motor and at least one electrical connection cable, at least one plug-in connecting means for the electrical contact of the stator winding with the electrical connection cable and a sealing element between the plug-in connecting means and a housing of the connection assembly. In conjunction with the motor housing of the electric motor, this connection assembly enables a fluid-tight seal of the corresponding side of the motor housing as well as an electrical contact of the stator winding by means of the plug-in connecting means. The connection assembly thus forms an interface that is sealed against fluid exchange as well as an electrical interface for the power supply of the electric motor.

In a particularly preferred application, the electronically commutated electric motor having a liquid-cooled stator can be used in the extraction of raw materials, especially in the extraction of crude oil and natural gas.

### BRIEF DESCRIPTION OF THE DRAWINGS

In the following, a non-limiting embodiment of the present disclosure is explained in more detail with reference to exemplary drawings, which show:

FIG. 1 a partially cutaway side view of an electronically commutated electric motor according to the present disclosure,

FIG. 2 a sectional view through the electric motor from FIG. 1,

FIG. 3 an exploded perspective view of the electric motor from FIG. 1,

FIG. 4 a partially cutaway, enlarged view of the connection assembly of the electric motor from FIG. 1, and

FIG. 5 a perspective view of a pre-assembled cable assembly for a connection assembly of the electric motor according to the embodiment from FIG. 1.

### DETAILED DESCRIPTION OF THE ENABLING EMBODIMENT

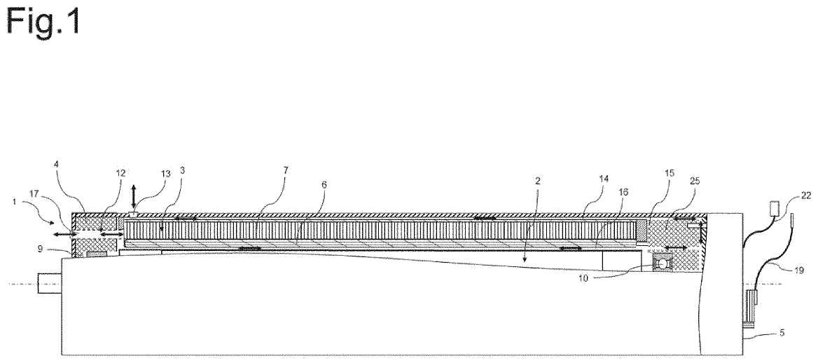

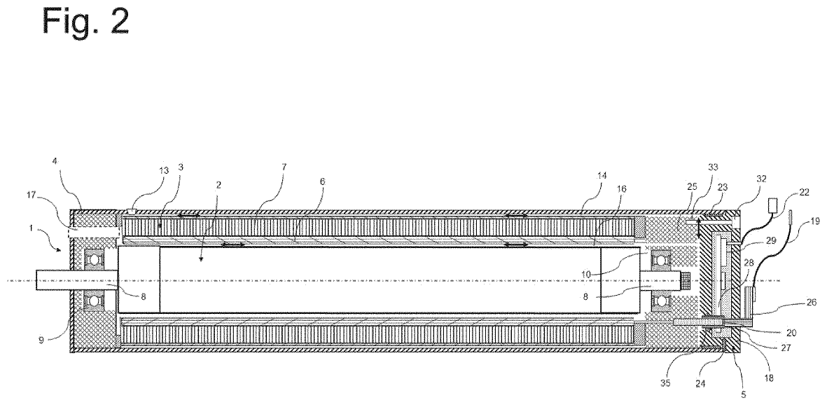

The electronically commutated electric motor 1 according to the present disclosure shown in FIGS. 1 and 2 is designed as an internal rotor and is liquid-cooled. The electric motor 1 comprises a rotor 2, which is concentrically aligned with a hollow cylindrical stator 3 and is rotatably arranged in the stator 3. The rotor 2 is shown uncut both in the partially cut-away side view of the electric motor 1 in FIG. 1 and in the associated sectional view in FIG. 2. The rotor 2 comprises at least one permanent magnet or several permanent magnet segments distributed around the circumference. In addition to the stator 3 and the rotor 2, all other components of the electric motor 1 according to the present disclosure can also be accommodated or arranged in a cylindrically configured motor housing 4, preferably made of steel. The first side of the motor housing 4 is closed in a fluid-tight manner with a connection assembly 5. The connection assembly 5 is used for the electrical contact of the electric motor 1. The essentially hermetic sealing of the motor housing 4 by the connection assembly 5 prevents both the leakage of coolant from the interior of the electric motor 1 and the penetration of undesirable media into the electric motor 1. Opposite the connection assembly 5 is the second side or output side of the motor housing 4. The motor housing 4 can be cup-shaped and designed in one-piece, wherein the bottom of the cup represents the second side of the motor housing and the open end of the cup represents the first side of the motor housing. The first open end of the motor housing 4 can be closed in a fluid-tight manner with the connection assembly 5. A one-piece motor housing 4 consisting of a cylindrical motor housing and the second side of the motor housing has the advantage that there is no transitional connection between the two parts through which coolant can escape from the inside of the electric motor 1 or undesirable media can penetrate into the electric motor 1. A one-piece motor housing 4 can also be manufactured more cost-effectively, as the cylindrical part of the motor housing does not have to be connected in a fluid-tight manner to the second side of the motor housing in an additional work step.

The liquid-cooled stator 3 of the electric motor 1 according to the present disclosure consists of an ironless hollow-cylindrical self-supporting stator winding 6, which is divided into several individual coils, and an externally arranged soft-magnetic reverse circuit connection 7. The external reverse circuit connection 7 consists of a laminated core, has also a hollow-cylindrically design and encloses the stator winding 6, wherein the reverse circuit connection 7 is in positive contact with the stator winding 6. The hollow-cylindrical stator winding 6 can be wound from a baked enamel wire, which is heated during manufacture and, when hardened, holds the stator winding 6 together at low temperatures in a dimensionally stable manner. Furthermore, a hollow cylindrical ceramic support sleeve may be provided, which is arranged inside and concentrically to the stator winding 6 for use at high temperatures. Such a ceramic support sleeve ensures the required air gap between rotor 2 and stator 3 even at high operating temperatures. The stator winding 6 can also be additionally coated with a potting compound, which increases the stability of the stator winding 6, particularly at high operating temperatures, and completely encapsulates the stator winding 6.

A rotor shaft 8, which extends coaxially to the rotor 2 through the rotor 2 or is attached to the rotor 2 as a stub shaft, is mounted both in a rolling bearing 9 arranged on the second side of the motor housing 4 and in an opposing second rolling bearing 10, which is accommodated in a front flange 25 in the region of the first side of the motor housing. The part of the rotor shaft protruding from the motor housing 4 can have connecting toothing.

The electronically commutated electric motor 1 according to the present disclosure further comprises a coolant circuit 12, having a coolant inlet 13, which is configured from a plurality of holes provided on the circumference of the motor housing 4 and arranged opposite the motor housing 4 in a circumferential recess, a first coolant channel 14, which extends annularly between the motor housing 4 and the outer circumference of the stator, a coolant redirection 15, which is configured between the front flange 25 and associated surfaces of the connection assembly 5 and preferably has several holes or openings in the front flange 25, a second coolant channel 16, which extends annularly between the inner circumference of the stator 3 and the rotor 2, and a coolant drain 17, which is configured by several holes at the bottom of the motor housing 4. The connection assembly 5 designed as closure cover 18 prevents coolant from escaping from the coolant circuit 12 by sealing the motor housing 4 in a fluid-tight manner.

As shown by the arrows in FIGS. 1 and 2, the coolant can either flow through the coolant inlet 13 into the coolant circuit 12 and from there via the annular first coolant channel 14, the coolant redirection 15 and the second annular coolant channel 16 to the coolant outlet 17, where the coolant exits the electric motor 1 again, or alternatively it can flow in the opposite direction through the coolant outlet 17, through the second coolant channel 16 and via the coolant redirection 15 and the first coolant channel to the coolant inlet 12, through which it then exits. In the first coolant channel 14 between the motor housing 4 and the outer circumference of the stator 3, the coolant absorbs the magnetization and eddy current losses in the reverse circuit connection 7, while when flowing through the annular second coolant channel 14 in the gap between rotor 2 and stator 3, the heat loss of the ohmic losses and eddy current losses in the stator winding 6 are dissipated. Since most of the power loss and thus the waste heat occurs in the stator winding 6 when the electric motor 1 is under high load, the cross-sections of the first coolant channel 14 and the second coolant channel 14 are dimensioned in such a way that a turbulent flow is achieved in the area of the second coolant channel 16 for optimum heat transfer. Since a thermal oil is used as coolant for the electric motor 1, both the rolling bearing 10 in the connection assembly 5 as well as the rolling bearing 9 on the bottom of the motor housing 4 are open towards the second coolant channel 16. This fluid-open connection to the rolling bearings 9, 10 enables both cooling and the supply of the rolling bearings 9, 10 with a lubricant.

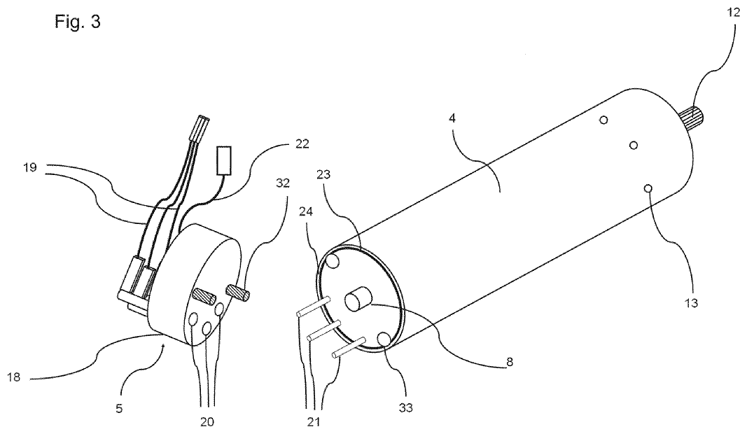

The perspective exploded view in FIG. 3 shows not only the motor housing 4, which is open at the front, with the rotor 2 and stator 3 accommodated therein, but further the separate connection assembly 5. In addition to the actual closure cover 18, the connection assembly 5 has three electrical connection cables 19, which are electrically connected via associated plug-in connection means 20 with corresponding plug-in connection parts 21 of the stator winding 6 when the connection assembly 5 is mounted on the motor housing 4. The connection assembly 5 further comprises a control line 22 with an associated plug for connecting the motor electronics (connection and/or commutation electronics) 28 of the electric motor 1. When assembling the electric motor 1, the connection assembly 5 can be plugged and fastened onto the open side of the motor housing 4 together with the closure cover 18. In order to securely seal the electric motor 1, in addition to a radial seal 23 to the inner circumference of the motor housing 4, an axial seal 24 can also be provided on the front flange of the motor housing 4. The use of an additional radial seal 23 to a conventional axial seal 24 enables a very high level of tightness of the electric motor 1 against the environment and also a high durability of the sealing function. The plug-in connection parts 21 connected to the stator winding 6 and the end of the rotor shaft 8 extend through the front flange 25, for fixing the stator 3 and supporting the rotor 2 via the rotor shaft 8 guided in the roller bearing 10.

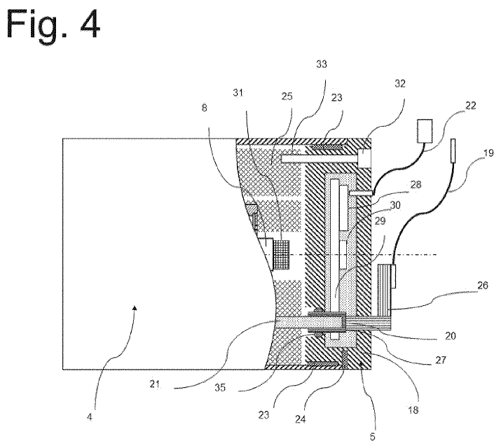

FIG. 4 shows a section through the connection assembly 5 attached to the motor housing 4. The connection assembly 5 is located with the associated closure cover 18 in the open front side of the cup-shaped motor housing 4, wherein the interior of the electric motor 1 is hermetically sealed, i.e. fluid-tightly sealed from the environment by means of the radial seal 23 and the axial seal 24 in the area of the adjacent closure cover 18. The connection cables 19 are connected to the plug-in connecting means 20 via busbars 26. As can be clearly seen in the enlarged view in FIG. 4, the plug-in connecting means 20 of the connection assembly 5 are configured as plug sockets 27, which are embedded in the housing of the connection assembly 5. In addition to the embedding in the housing of the connection assembly 5, an O-ring 35 is provided at the open end of the plug sockets 27 opposite the housing of the connection assembly 5, which improves the sealing of the plug sockets 27 and thus also the electrical contact with the busbar 26 and the connection cables 19. The pin-shaped configured plug-in connection part 21, which extends from the stator winding 6 through the front flange 25, is accommodated in the plug socket 27 and enables electrical contact of the stator winding 6 of the stator 3.

In addition to the closure cover 18 with the plug sockets 27 embedded therein as well as the associated busbars 26 and connection cables 19 for supplying power to the stator winding 6, the connection assembly 5 also comprises the motor electronics 28, which is embedded in the housing of the connection assembly 5 having all components of the commutation electronics and a sensor 30, preferably a magnetic field-sensitive angular position sensor. The sensor 30 detects the magnetic field of a control magnet 31 mounted at the end of the rotor shaft 8 in order to control the operation of the electric motor 1.

During the manufacture of the connection assembly 5, in a first process step, the motor electronics 28 with the printed circuit board 29, the electronic components for the commutation, the sensor 30 and the connections of the control line 22 is overmolded on all sides with a defined material thickness of a preferably thermoplastic resin or alternatively thermosetting resin, for example in a thermoplastic injection molding, a thermosetting transfer molding or a mold casting. In a second process step, this component having the actual housing of the connection assembly 5 is again overmolded or cast with a thermoplastic or thermosetting plastic material to form the closure cover 18, so that possible holding positions from the first process step are also securely sealed against the liquids in the electric motor 1.

As already shown in FIG. 3, the connection assembly 5 is detachably connected to the motor housing 4 by inserting the plug-in connecting means 20 onto the plug-in connecting parts 21 and the closure cover 18 into the open end on the first side of the motor housing 4. In addition to the plug-in connection of the closure cover 18 and the plug-in connecting means 20, in the embodiment shown in FIG. 3, the connection assembly 5 can be detachably screwed into the motor housing 4 via screws 32 and corresponding threaded holes 33. Alternatively, a connection of the connection assembly 5 with the motor housing 4 can also be realized by means of a latching mechanism. This connection can also be designed to be non-detachable, for example by latching or gluing, in order to prevent the connection from loosening itself due to vibrations.

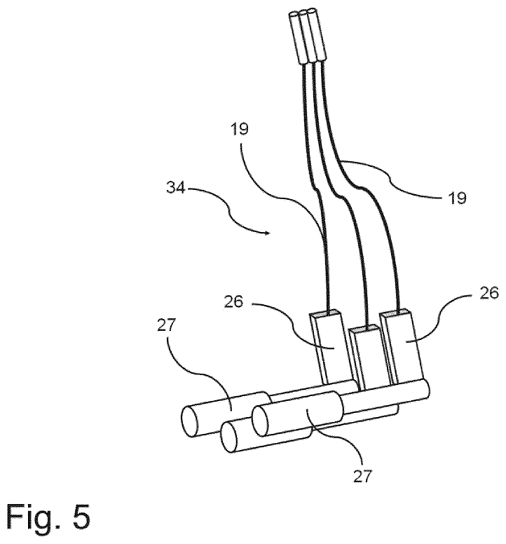

FIG. 5 shows a pre-assembled cable assembly 34 with three connection cables 19, each of which is connected to a busbar 26 and a plug socket 27. The busbars 26, for example made of copper, can be connected to the plug sockets 27 by pressing, welding or soldering. The connection cables 19 can in turn be connected to the busbar 26 by welding or soldering. Furthermore, the individual connection cables 19, busbars 26 and associated plug sockets 27 are combined to form a common cable assembly 34 so that the cable assembly 34 can be added during the manufacture of the connection assembly 5 in the second process step for manufacturing the housing of the connection assembly 5 and forming the closure cover 18. During the manufacturing process of the connection assembly 5, the plug sockets 27 are held by a molding tool in a position defined for the connection to the plug-in connecting parts 21, so that when the connection assembly 5 is later mounted on the motor housing 4, the plug sockets 27 fit exactly to the position of the plug-in connecting parts 21 provided in the motor housing 4.

### LIST OF REFERENCE SYMBOLS

1 Electric motor
2 Rotor
3 Stator
4 Motor housing
5 Connection assembly
6 Stator winding
7 Reverse circuit connection
8 Rotor shaft
9 Roller bearing
10 Roller bearing
12 Coolant circuit
13 Coolant inlet
14 First coolant channel
15 Coolant redirection
16 Second coolant channel
17 Coolant outlet
18 Closure cover
19 Connection cables
20 Plug-in connecting means
21 Plug-in connecting parts
22 Control line
23 Radial seal
24 Axial seal
25 Front flange
26 Busbars
27 Sockets
28 Motor electronics (connection and/or commutation electronics)
29 Printed circuit board
30 Sensor
31 Control magnets
32 Screws
33 Threaded holes
34 Cable assembly
35 O-ring

What is claimed is:

1. An electronically commutated electric motor having a liquid-cooled stator with an ironless hollow-cylindrical stator winding and a coolant circuit for passing a coolant through the electric motor, a rotor arranged concentrically rotatable to the stator, a motor housing accommodating the stator and the rotor, a connection assembly(s) and at least one electrical connection cable for the electrical contact of the stator winding,
wherein the connection assembly has a closure cover and at least one plug-in connecting means for the electrical contact of the electrical connection cables with a corresponding plug-in connecting part of the stator winding of the stator, wherein in the connection assembly effects a fluid-tight sealing of the motor housing, and wherein a sealing element is provided between the plug-in connecting means and a housing of the connection assembly.

2. The electric motor (according to claim 1, wherein the stator has a stator winding with three stator winding phases and three plug-in connecting parts, each connected to a stator winding phase, which are positioned on the first side of the motor housing, and the connection assembly(s) has three plug-in connecting means, each of which is connected to an electrical connection cable.

3. The electric motor according to claim 1, wherein the plug-in connecting means of the connection assembly is configured as a plug socket and the corresponding plug-in connecting part of the stator winding is preferably configured as a contact pin.

4. The electric motor-according to claim 3, wherein an O-ring is provided as a sealing element between the plug socket and a housing of the connection assembly.

5. The electric motor according to claim 1,
wherein a radial seal is provided between the connection assembly and the motor housing.

6. The electric motor according to claim 1,
wherein a cable assembly is provided, wherein the cable assembly comprises the electrical connection cables, the plug-in connecting means and at least one busbar for the electrical contact of the electrical connection cables with the plug-in connecting means.

7. The electric motor according to claim 6, wherein the cable assembly has three electrical connection cables, three plug sockets and three busbars, wherein the three electrical connection cables, the three plug sockets and the three busbars are mechanically connected to one another.

8. The electric motor according to claim 1,
wherein the connection assembly is made of a thermoplastic or thermosetting resin by means of injection molding or mold casting, wherein a connection electronics having the electrical connection cables and the plug-in connecting means are embedded in the connection assembly.

9. The electric motor according to claim 8, wherein commutation electronics are provided for commutating the electric motor, wherein the commutation electronics are embedded in the connection assembly.

10. The electric motor according to claim 9, wherein the commutation electronics have an integrated sensor, which in particular detects the magnetic field of a diametrical control magnet mounted at the end of a rotor shaft.

11. The electric motor according to claim 8,
wherein the connection electronics and/or the commutation electronics are provided with an additional layer of a thermoplastic or thermosetting resin, which is applied in an upstream step by means of injection molding, transfer molding or mold casting.

12. The electric motor according to claim 1,
wherein the coolant circuit for passing a coolant through the electric motor comprises a first coolant channel between the motor housing and the outer circumference of the stator, a second coolant channel between the inner circumference of the stator and the rotor and a coolant redirection for fluid connection of the first coolant channel and the second coolant channel, wherein the coolant redirection is configured, preferably at least partially, by the connection assembly.

13. The electric motor according to claim 12, wherein the second coolant channel between the inner circumference of the stator and the rotor has a smaller cross-sectional area than the first coolant channel between the motor housing and the outer circumference of the stator.

14. The electric motor according to claim 12, wherein the coolant circuit has a coolant inlet to the first coolant channel arranged on the circumference of the motor housing, and has a coolant outlet from the second coolant channel, which is arranged on a second side of the motor housing opposite the connection assembly.

15. A connection assembly for an electronically commutated electric motor according to claim 1, wherein the connection assembly has a closure cover of the electronically commutated electric motor and at least one electrical connection cable, at least one plug-in connecting means for the electrical contact of the stator winding with the electrical connection cable as well as a sealing element between the plug-in connecting means and a housing of the connection assembly.

16. The electric motor according to claim 10, wherein the integrated sensor is a magnetic field-sensitive angular position sensor.
